(19) United States
(12) Patent Application Publication
(10) Pub. No.: US 2024/0012186 A1
(43) Pub. Date: Jan. 11, 2024

(54) CONVEX DEVICE CASE FOR PROVIDING A MIRRORED, MINIMIZED IMAGE TO EMULATE THE IMAGE CAPTURED BY A CAMERA OF A DEVICE

(71) Applicant: Javier Garavito, Miami, FL (US)

(72) Inventor: Javier Garavito, Miami, FL (US)

(21) Appl. No.: 17/861,356

(22) Filed: Jul. 11, 2022

(51) Int. Cl. G02B 5/10; H04B 1/3888; G02B 7/182

(52) U.S. Cl. CPC G02B 5/10; H04B 1/3888; G02B 7/182

(57) ABSTRACT

A convex device case for providing magnification to emulate the zoom of a camera of a cellular device is disclosed. This convex device case comprises a body having a front side and a back side, a receiving section on the front side, and a convex reflective surface on the back side. This convex device case includes a convex mirror configured to provide a virtual image of reduced size as to emulate the photograph captured by a phone of standard zoom, typically defined as 1× zoom. It allows the user to visualize the captured image by the phone while using the rear camera prior to taking the photograph.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of mobile phone accessories, and more specifically to the field of mobile phone protective covers providing a convex mirrored surface.

### BACKGROUND

In many countries around the world, the majority of the population owns at least one handheld telephone. Ever since the telephone has become mobile, tech companies have charged at the opportunity to market the product to a wide range of consumers, thereby giving people of different ages and backgrounds the opportunity to own a personal telephone that suits their everyday needs. As the popularity of these products grew, so did the customers' demands. To innovate the personal cellphone, tech companies began incorporating the functions of different devices into the new mobile phone. For example, many cell phones started incorporating cameras in their devices. Later on, GPS was added, and before we knew it the market had been presented smart phones, or handheld computing devices. The concept of a smart phone was to create a cellular telephone with an integrated computer including features such as operating systems, web browsing, and the ability to run software applications. However, the smart phone feature with the highest demand was the camera. The consumer base has consistently demanded increased quality and functionality of the camera to capture life events in the current age of social media. Over time, the smart phone's camera feature has propelled the device into the market of personal compact cameras. Tech companies have continued to develop and optimize the camera quality and abilities to intrigue the consumer. For example, a front facing camera was added so that the user may see his or herself while taking a photo, or multiple cameras have been added the back of the phone such as higher resolution lens', and different cameras for certain lighting situations, thereby to produce the best quality photo.

The majority of smart phones on the market currently have a front facing camera and a rear facing camera. The rear facing camera typically has a higher resolution and best final quality of the photos and videos taken by them. Both types of cameras handle a standard optical zoom in the smartphone industry, which is often called “ 1×”, of which photos and videos are taken at a short distance from the person or group of people who are the subject of the photo or video.

Normally, selfies are taken with the front cameras since they are taken by the same person who is holding the camera. Photo and video captured in this way can be seen in real time presenting the previous image of the photo or live video, which is being taken. If these same photos or videos “selfies” were to be taken with the rear cameras, they would not be able to see the image that is on the smartphone screen as it would appear in the photo or video. On the other hand, if the photo or video is taken by a third person, normally the photographer or videographer will use the rear cameras and therefore the person being photographed or filmed will never be able to see in real time and actual size as seen on the smartphone screen. The current problem faced by the great majority of smart phone users is the fact that when taking a photo or video using the rear facing camera there is no way to see in real time and size, how the video or photo appears on the smartphone screen. This problem exists no matter who is capturing the photo or video. For example, whether the user is taking their own photo or if a third-party person is taking a photo of the user, there still no way for the subject to see the actual media being captured.

As a result, there exists a need for improvements over the prior art and more particularly for a device to assist smartphone users when taking photos or videos using the rear facing camera.

### SUMMARY

A convex device case for providing diminishing magnification to emulate the (1× zoom) (defined below) of a camera of a cellular device is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a convex device case for providing a reduced magnification to emulate the zoom of a camera of a cellular device is disclosed. The convex device case comprises a body having a front side and a back side, a receiving section on the front side, and a mirrored surface or convex mirror on the back side. The mirrored surface may be the back side of the convex device in one embodiment, and in others, may be a surface in attachment with the back side of the device. This convex device case contains a convex mirror proportioned to the exact size of the smartphone, as to emulate the image captured by a rear camera of a cellular device if its standard zoom. The case has a mirrored surface with a radius of curvature of 225 mm which allows the image displayed on the mirror to be reduced in size as to emulate the actual size of the image being captured by the camera. The back side also includes a window or opening 335 for the camera lens, the window may appear as a clear film or an unobstructed opening for the rear facing camera. In certain embodiments, the receiving section of the convex device case may comprise a lip extending inward from at least one side wall of the body. By having a convex mirror on the back of a smartphone, an exact image that will be captured by the smartphone will be reflected to the user. The properties of the convex mirror allow the subject to be reduced so that the user may visualize the image that will be captured prior to taking the photograph. Therefore, because the convex mirror is the same size as the screen on the smartphone, as is incorporated into the case, the reflection emulates the photograph that will be captured by the rear facing camera. In certain embodiments, the convexity of the mirror is proportioned to emulate the standard optical zoom of a smartphone, which is generally referred to as 1× zoom or 1 times zoom, meaning that lens of the camera has not been adjusted to zoom in on the subject object, and that the camera is taking a photograph as the subject objects appear, irrespective of distance to the camera lens.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIGS. 1A and 1B illustrate an example embodiment of present technology depicting a front view and a back view of a device having at least one camera on the back side of the device;

FIGS. 2A and 2B illustrate example embodiments of prior art;

FIG. 3 is a perspective view of capturing a photograph of subject matter using the device, with at least one camera on the back side, having a convex mirrored, minimized image to emulate the image captured by a camera of a device, according to an example embodiment;

FIG. 4 is a front perspective view of a convex device case providing a mirrored, minimized image to emulate the image captured by a camera of a device, secured to the device, according to an example embodiment;

FIG. 5 is a front perspective view of the convex device case, according to an example embodiment;

FIG. 6 is a back perspective view of the convex device case, according to an example embodiment;

FIG. 7 is a front view of the convex device case, according to an example embodiment;

FIG. 8 is a back view of the convex device case, according to an example embodiment;

FIG. 9 is a right-side view of the convex device case, according to an example embodiment;

FIG. 10 is a left side view of the convex device case, according to an example embodiment;

FIG. 11 is a top side view of the convex device case, according to an example embodiment;

FIG. 12 is a bottom side view of the convex device case, according to an example embodiment;

FIG. 13A and 13B illustrate a cross-sectional top-side view of the convex device case having the device disposed within, according to an example embodiment;

FIG. 14A and 14B illustrate a cross-sectional right-side view of the convex device case having the device disposed within, according to an example embodiment;

FIG. 15A is a convex device case, according to a second example embodiment;

FIG. 15B and 15C illustrate a cross-sectional right-side view of the second example embodiment of the convex device case having the device disposed within;

FIG. 16A is a convex device case, according to a third example embodiment;

FIG. 16B and 16C illustrate a cross-sectional right-side view of the third example embodiment of the convex device case having the device disposed within;

FIG. 17 is a back perspective view of the convex device case having the device within, according to either the second or third example embodiment; and

FIG. 18 is a perspective view the convex device case as an attachment or accessory defined by convex mirrored body securing to a device or device case, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a convex device case for providing magnification to emulate the zoom of a camera of a cellular device. Because the case includes a convex mirrored surface, the backside of case provides the user with a reflection that is a virtual image of reduced size of the photographs subject matter. Therefore, the subject matter of the photograph can visualize the image that will be captured by the device, prior to the taking of the photograph. For example, a user may take a selfie using the rear facing camera of a device which would allow them to see them to see a reflection, which is virtual and reduced in size, which is an exact replica of the photograph that would be taken by the user. In certain embodiments, the convex mirrored surface is dimensioned as to emulate the photograph captured by a standard camera zoom, or 1× zoom, further defined below. However, in other embodiments, the convex mirrored surface may be dimensioned to provide a virtual, minimized image, emulating wide angle cameras, such as 0.5× zoom, for example.

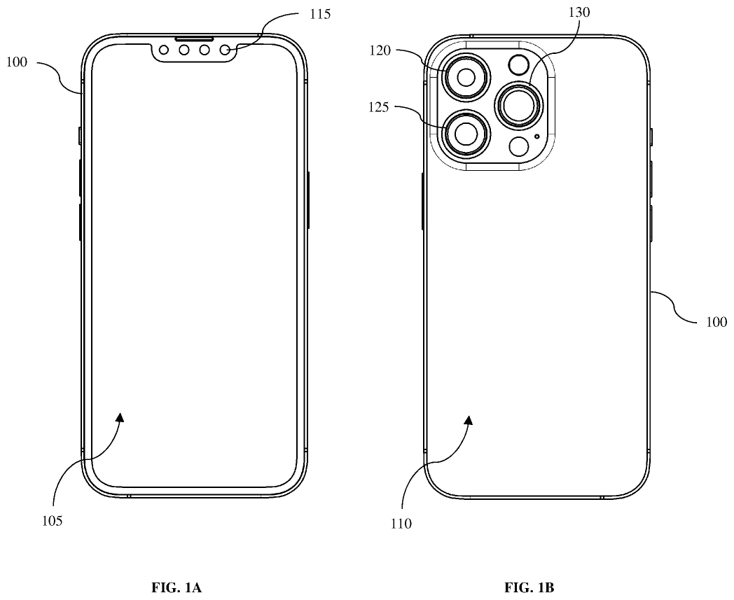

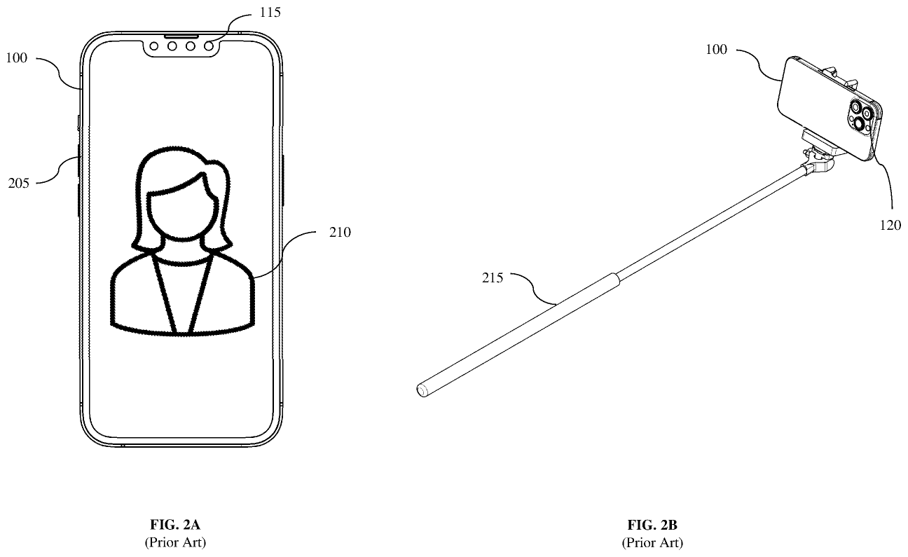

Referring now to the Figures, FIGS. 1A and 1B illustrate embodiments of the present technology that may utilize the present invention disclosed herein. Specifically, FIGS. 1A and 1B depict an example smartphone or device 120. It is understood that the device 100 may be any smartphone, tablet, camera, and/or other portable device having at least one camera on a back side of the device. FIG. 1A depicts a front side 105 of the device 100 and FIG. 1B depicts a back side 110 of device 100 according to an example embodiment. As illustrated, device 100 includes a front facing camera 115 and at least one rear facing camera, as shown, having first camera 120, second camera 125, and third camera 130. In the present example embodiment, the cellular device includes three rear facing cameras; however, it is understood that the device may include as few as one camera. As shown, the first camera 120 is generally a 12-megapixel wide camera having a 26 mm focal length and an f/1.8 aperture. It is understood in the art, in the field of optics, that the aperture and the focal length of the optical system, in this case the rear facing camera 120, determine the cone angles and the bundles of light rays that come to focus the captured images. It is understood that the first camera is generally the industry standard camera, where the industry standard camera has a focal length of 26 mm, which may be referred to herein as the “standard camera” or the “primary lens”. The primary lens generally has a normal field of view, of which the normal field of view is referred herein as “1× zoom”. The second camera 125 is generally a 12-megapixel telephoto camera having a 52 mm focal length and an f/2.0 aperture. The increased focal length provides for a “zoomed in” photograph with more detail. The third camera 130, is generally a 12-megapixel ultra-wide camera having a 13 mm focal length and an f/2.4 aperture. Generally, the field of view of the third camera is 120 degrees, which is sometimes referred to as 0.5× zoom. The front facing camera 115 of the device is generally a camera of lower resolution than those disposed on the back side of the device. For example, the front facing camera 115 has lower megapixel resolution than the camera(s) on the back side, e.g., the front facing camera 115 is a 7-megapixel camera whereas the camera(s) on the backside are generally at least 12 megapixels. Thus, a photograph captured by the front facing camera is usually of poorer quality than a photograph taken by a rear camera.

It is understood that the invention described herein is assumed to be described based on the standard camera of normal optical zoom or 1× zoom, unless otherwise provided; however, it is further understood that the invention may be dimensioned, in other embodiments, to emulate any camera on device, as-long-as said camera minimizes the subject matter.

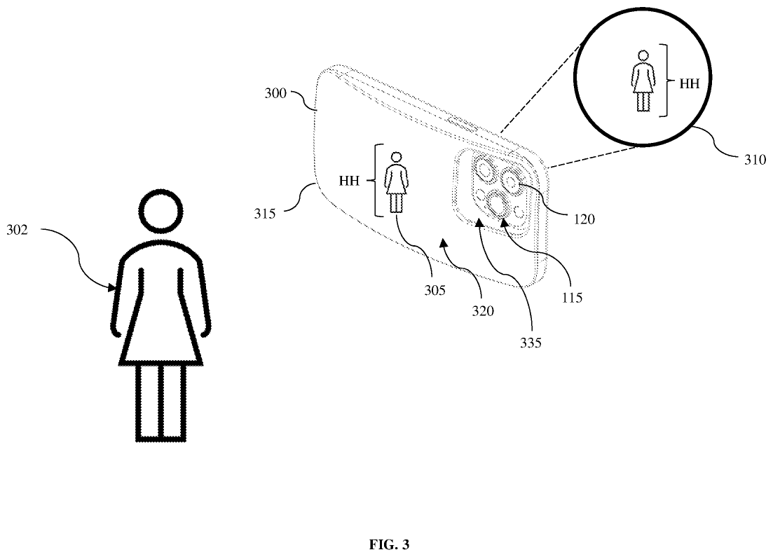

FIGS. 2A and 2B illustrate example embodiments of the prior art. It is understood that the device 100 shows a real time display of the image to be taken through the lens of the camera on the screen on the front side of the device. Many devices contain a screen that displays a representation of what the camera sees in real time. This screen aids users in positioning themselves at a specific angle or distance relative to the camera in which they prefer. However, this feature limits the user to using the front facing camera.

FIG. 2A depicts a user taking a selfie, which is a photograph that a user takes of oneself, using the front facing camera 115 of device 100. To take a selfie, a user generally holds the device 100 in his or her hand, orients oneself within the camera frame, and then captures the photograph 210 by clicking the capture button 205. First, the problem with taking a selfie with the front facing camera is that the front facing camera produces an image of lower resolution than if the selfie was taken with the back facing camera. Second, if a user took a selfie with a back facing camera, notwithstanding that the user would have a better resolution and quality photograph, then user would not be able to see image that would be captured. The user is essentially taking a ‘blind’ photograph hoping that oneself is oriented in the proper position, has adequate lighting, and the subject matter is positioned within the camera frame. (As shown in FIG. 2B, the back of the device has no screen to display the subject matter as viewed through the lens of the camera, thereby leaving the user to position themselves by chance.) Therefore, to see the prospective image, a user taking a photograph with a rear facing camera may align themselves in front of a mirror so that they can see the front side of the device while pointing the camera on the backside of the device at oneself. Third, some existing devices have a reflective metallic surface on the back side which may be used by the user as a mirror. However, this is not suitable to capturing a photograph because as a plain flat mirrored surface, the size of the subject matter is unchanged. Thus, if a user was taking a selfie with the rear facing camera and was using the reflective properties of the back side of the device to position themselves, then the user would still not accurately take the photograph. This is because the standard camera of normal field of view minimizes the subject matter, which is why taking a close selfie of the users face results in a photograph depicting substantially all of the user's face, rather than a portion of the users face. As a result, there exists a need for improvement over the prior art, more specifically, a way to provide the user of a rear facing camera to visualize the prospective image to be captured by a device.

FIG. 2B illustrates another common device and method used to take selfies, which has been publicly acclaimed as “the selfie stick”. The selfie stick, or device 215, is configured to hold a device 100 having at least one camera, such as first camera 120. It is understood that users will generally use the selfie stick by orienting the front side of the device 100 towards the handle of the selfie stick. The selfie stick was designed to provide users with an elongated holder for camera devices to allow the user to capture oneself in a broader field of view. That is, the standard camera of normal field of view and 1× zoom is dependent on the distance relative to the subject matter. Therefore, to capture more of the background and foreground around the subject matter, the camera needs to be disposed further away from the subject matter, i.e., the user. Thus, the user disposes the device 100 in the selfie stick which provides an extension to accomplish the goal of having more background and foreground in the image. Given phone is further away from the user, it is more difficult to properly position oneself within the frame. Therefore, the front facing camera is generally used so that the user can see the prospective image to be captured on the screen. However, as previously stated, this results in poorer quality images. As a result, if the user utilizes the rear camera, then the user does not currently have a way of visualizing the prospective image to be captured by the device. As a result, there exists a need for improvement over the prior art, more specifically, a way to provide the user of a rear facing camera to visualize the prospective image to be captured by a device.

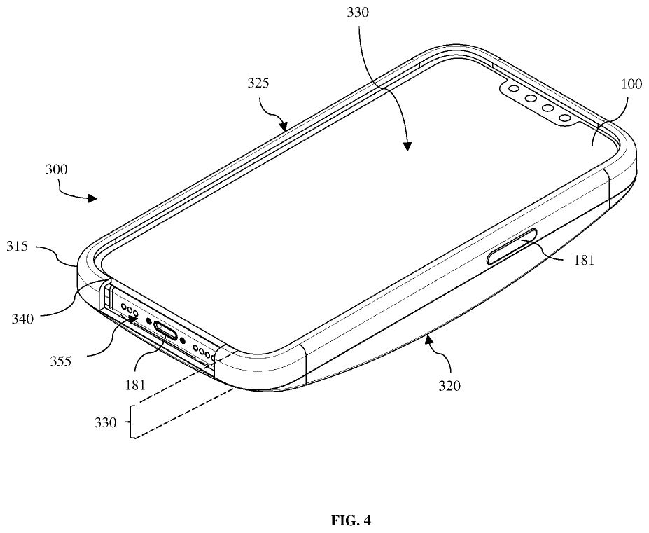

Referring now to FIG. 3, a perspective view of capturing a photograph of subject matter 302 using the device 100 having a convex device case 300 having a convex mirrored surface is shown, according to an example embodiment. The convex device case 300 provides a mirrored, minimized virtual image 305 of the subject matter 302, to emulate a captured image 310 that will be captured by the first camera 120 disposed on the back side of device 100. The convex device case is defined by a body 315 having a front side (not shown) and a back side 320. The back side includes a convex mirrored surface. As shown in FIG. 3, the back side 320 is the convex mirrored surface, however, in other embodiments, the back side may include a convex mirrored surface on a portion of the back side and/or the back side may be removably in attachment with a convex mirrored surface. The mirrored surface may be defined as the back side of the convex device in one embodiment (that may be coated with a shiny material, such as aluminum for example), and in others, may be a surface in attachment with the back side of the device, such that the mirrored surface is any reflective surface. A mirrored surface is generally a surface of any material that provides a reflection. The mirrored surface is generally a smooth surface to provide a clear reflective image. Generally, the mirrored surface is aluminum or other shiny metal. In certain embodiments, the mirrored surface is a reflective surface, typically glass coated with a metal amalgam that reflects a clear image. In other embodiments, the mirrored surface may be made out of aluminum, for example, a thin film of aluminum applied to an acrylic or other plastic substrate to define the mirrored surface.

The mirrored surface is convex, such that it curves outward from the device 100. The convex mirrored surface produces a virtual, upright image of the user or object that is the subject matter. For example, as shown, the subject matter 302 is shown as image 305 where image 305 is an upright and virtual image of the subject matter 302. In optics, a virtual image is the image formed from the apparent divergence of light rays from a point, as opposed to an image formed from their actual divergence. Ideally, the mirrored surface is spherical convex mirror, meaning that mirrored surface bulges outward from the device 100 in a plurality of directions, much like a shell of a sphere, having an apex in the middle of the bulge. In other embodiments, the mirrored surface is aspherical convex such that the mirrored surface is still a convex mirror that produces a virtual, upright image of the subject matter. Notwithstanding the type of convex mirror, spherical or aspherical, the mirrored surface is convex such that it always has a magnification less than 1. By definition, convex mirrors always produce a virtual, upright image with a magnification less than one. A magnification less than 1 means that the subject matter 302 is reduced in size as shown by the mirrored image 305. The magnification factor by which the subject matter is reduced in size as shown on the mirrored surface depends upon the radius of curvature of the convex mirrored surface (discussed below).

Ideally, as discussed below, the convex mirror is configured to minimize the image of the subject matter to emulate the reduced image of the subject matter as captured by the camera. FIG. 3 shows that the mirrored image 305 has a height HEI that is the same as the height of the captured image 310. Therefore, the convex mirrored surface on the convex device case provides a reflection that emulates the prospective image that will be captured by the rear facing camera. This improves over the prior art because (1) the user can visualize the prospective image to be captured, and (2) the user captures a photograph with the rear facing camera that results in better quality. Because the convex mirrored surface extends to all sides of the body, the reflective image is also the exact size of the prospective photograph shown on the screen of the device. To emulate the image captured by the standard camera with a focal length of 23 mm, being 1× zoom, the convex mirrored surface has a radius of curvature of approximately 225 mm. To emulate the field of view of cameras having other focal lengths, the radius of curvature may vary accordingly. The larger the radius of curvature, then the less reduced the virtual upright image appears, such that the convex mirror approaches the point of being a plain mirror. Similarly, the smaller the radius of curvature the more the virtual upright image is reduced in size. It is understood that the further away the subject matter is away from the camera, then the smaller the virtual image of the object will appear with respect to the actual size of the object. It is further understood that the magnification of a convex mirror is defined by the height of the virtual image divided by the height of the object. As such, the height of the image depends on the subject matters distance relative to the camera. It is estimated that the magnification factor of the convex reflective surface, having a radius of curvature of 225 mm, is 0.5 as based on a person taking a selfie (a distance of roughly less than a meter).

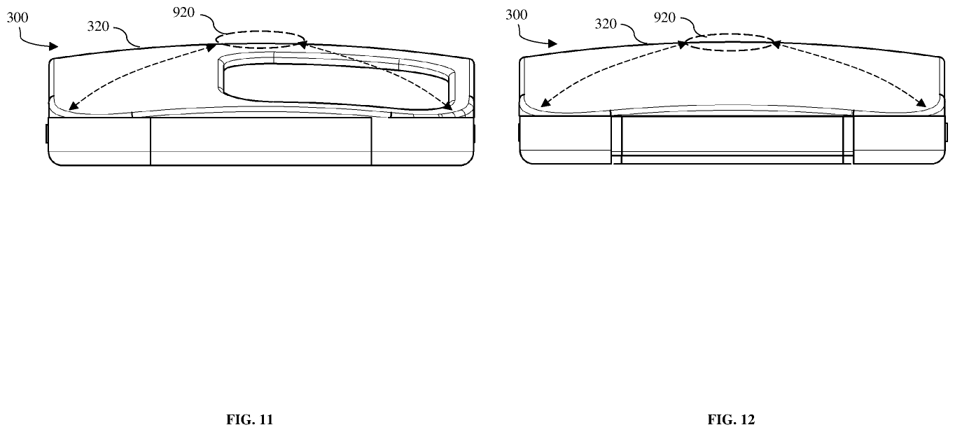

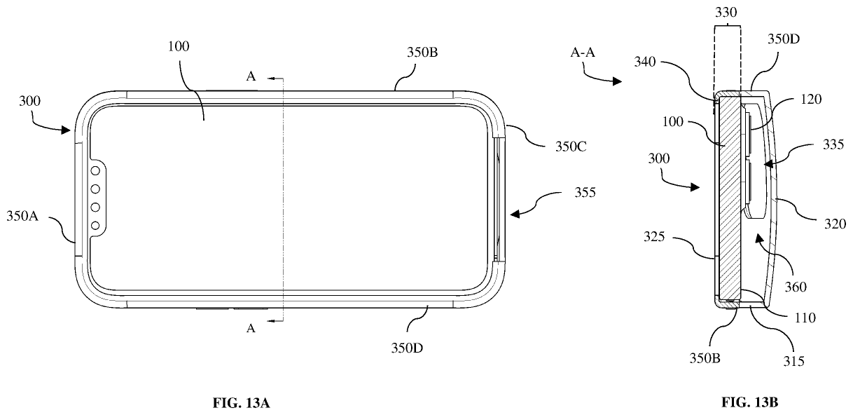

Referring now to FIGS. 4 through 14B, a convex device case 300 for providing a mirrored, minimized image to emulate the image captured by a camera of a device is shown, according to a first example embodiment. The convex device case 300 includes a body 315 having a front side 325 and a back side 320. The convex device case 300, and/or body 315, may be formed from a single piece or from several individual pieces joined or coupled together. For example, the front side of the body may be configured to removably mate with the back side of the body to allow the convex device case to encompass and/or receive a device. The components of the convex device case 300, and/or body 315 may be manufactured from a variety of different processes including an extrusion process, a mold, casting, welding, shearing, punching, folding, 3D printing, CNC machining, etc. The case may be comprised of metallic materials such as carbon steel, stainless steel, aluminum, titanium, other metals or alloys, composites, polymeric materials such as polycarbonates, such as acrylonitrile butadiene styrene (ABS plastic), Lexan, and Makrolon™, etc. Other materials or manufacturing processes may also be used and are within the spirit and the scope of the present invention.

The convex device case may be dimensioned to fit any device within the spirit and scope of the disclosure. In other embodiments, the shape and size of the case may appear differently, suitable for a different type of device, such as a tablet and/or camera, and/or smart phone of various brands and manufacturers. The present embodiments herein (FIGS. 3 through 18) are drawn to scale for an iPhone® 13 Pro, according to one example embodiment. In other embodiments the shape of the body may be longer or shorter than the present embodiment, the corners of the case may be rounded or squared off to a sharp edge, and the camera opening may appear longer or wider to accommodate the number of cameras present on the back side of the respective device.

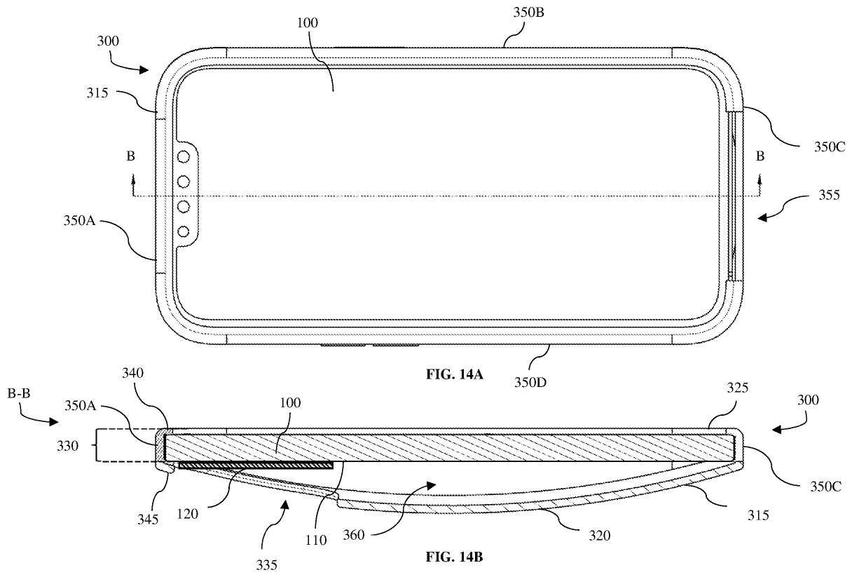

The body includes a plurality of side walls (further defined below and identified in FIGS. 13A through 14B) which include may include an opening, such as opening 355, to access features and/or functions of the device, such as charging port 180 and power button 181. Each of the side walls may further include a cover or panel to protect and/or cover the functions and/or features of the device to protect the device from damage caused by water, dirt, and other contaminants.

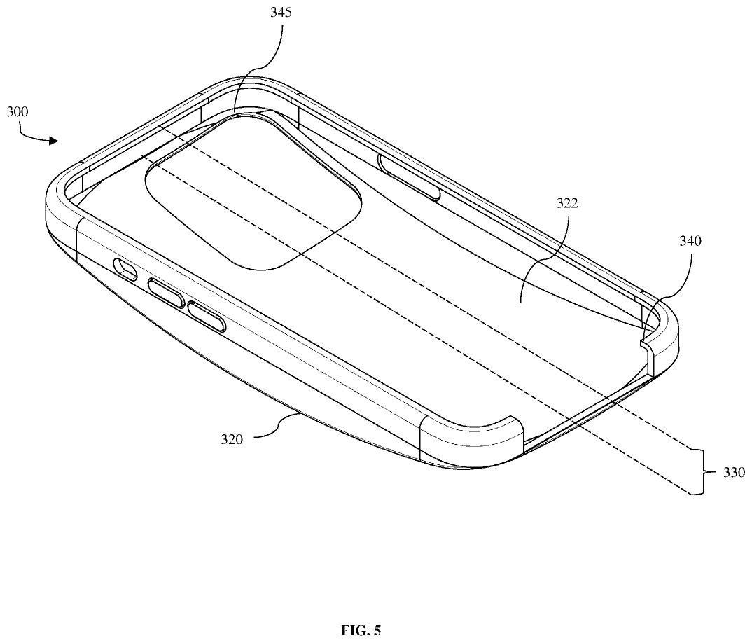

As shown in FIG. 5, the convex device case 300 has an inner wall 322 of the back side 320. In this embodiment, as shown, viewing from the perspective of the front side of the device case 300, the inner wall concaves inward so that the back side 320 is convex. In other embodiments, as described herein below, may be planar (not concave) as to support the back side of device 100 while maintain that the mirrored surface 320 is convex. It is understood that the back side of the cellular device is the opposite side of the display of the device. The back side of the body includes a camera opening or window 335 to allow for the camera of the device to have an unobstructed view of the subject matter. The camera opening 335 may also be dimensioned differently in other embodiments depending on the device and its respective cameras. For example, some devices have a single rear facing camera, others may have up to three or four cameras on the back side of the device. A single camera would require a smaller camera opening, whereas a phone with quad-cameras on the back of the device would require a larger opening to allow unobstructed view-lines to the subject matter. As such, the opening 335 may be dimensioned accordingly.

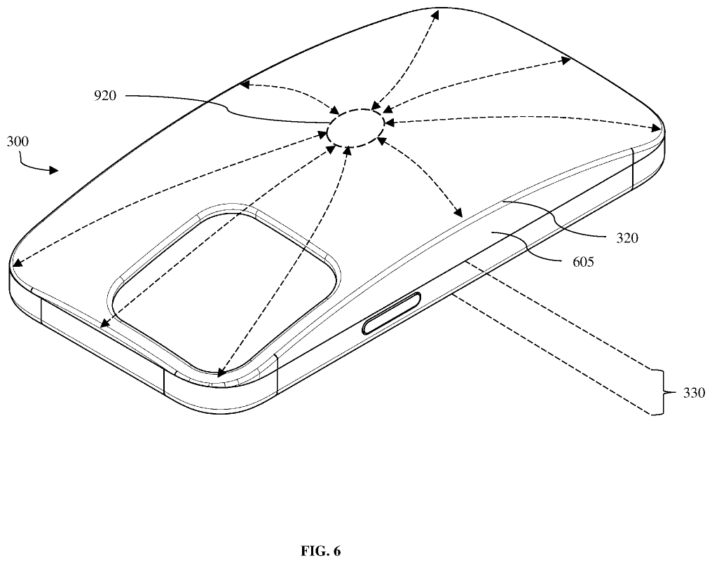

FIGS. 6, 11, and 12 serve to illustrate the spherical convex shape of the mirrored surface. As shown, the mirrored surface has an apex 920 which is the highest point on the mirrored surface 320 or back side. FIG. 6 specifically shows how the mirrored surface curves in all directions towards the apex and/or from the apex towards the edges of the device 300 and/or towards the sides of the convex device case 300. Because the length of the device 300 is greater than the width of the convex device case 300, the spherical nature of the mirrored surface does not uniformly align with the rectangular profile of the device case. As such the device case may have extension walls 605 (that may constitute part of the sides of the device) extending from the receiving section 330 up to the mirrored surface 320. The extension walls vary in height along the profile of the side of convex device case up to the curvature of the mirrored surface.

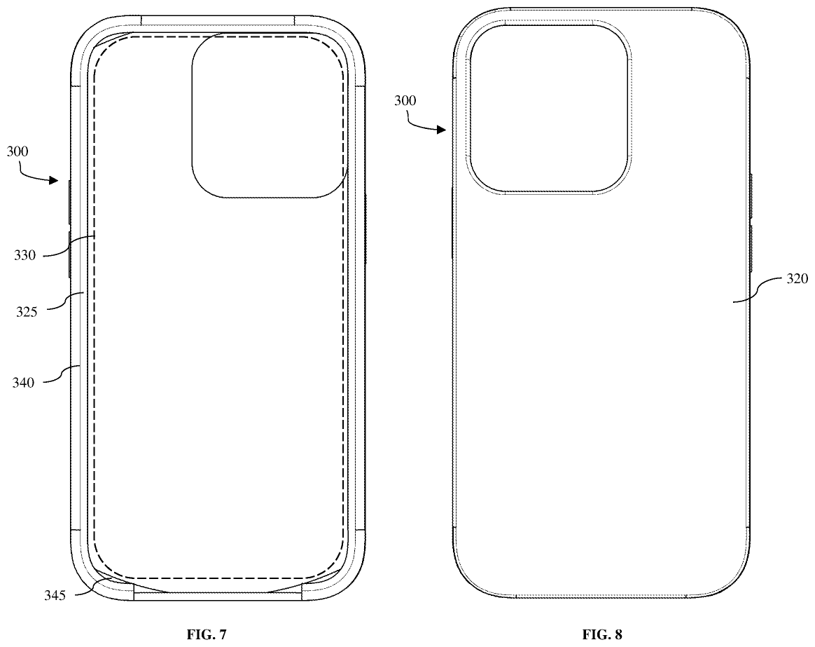

Referring to FIGS. 7 and 8, a front view and back view of the convex device case is shown, respectively, according to an example embodiment. The lip acts as a securing element for the phone. The flexible lip 340 on the front surface 325, extends inward from the wall forming a top surface which is configured to engage the top surface of the device 100. The lip may be made from a synthetic elastomer such as silicone rubber allowing the device to force the body to bend the flexible lip when force is applied to the device while inserting it into the receiving section 330 (represented by dotted lines in the front view). The lip 340, which extends about the perimeter of the front side and the receiving section, secures the device within the receiving section. Once within the receiving section, lip 345 engages the back side of the device to also support the device within the receiving section.

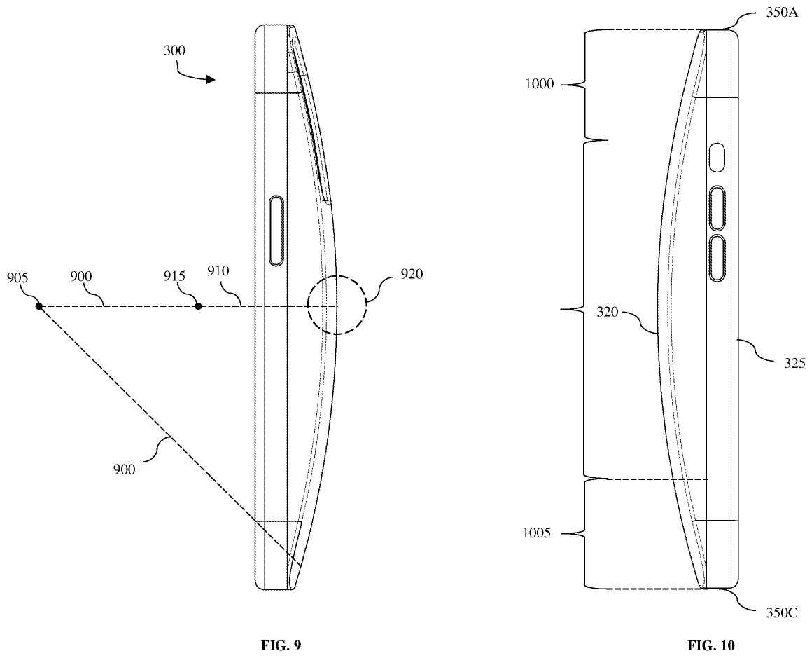

FIG. 9 illustrates a right-side view of the convex device case providing a visual representation of the radius of curvature 900 and the focal length 910, according to this example embodiment. It is understood that the focal length 910, which determines the focal point 915 in optics, changes with respect to the center point 905 of the radius of curvature 900. The radius of curvature is not drawn to scale. The focal point is generally one-half the radius of curvature, or one half the distance from the apex of the convex mirrored surface to the center point. In this embodiment, because the back side is spherical convex, any point on the back side has the same radius of curvature, the same center point. The apex 920 of the convex mirrored back side is the highest point of the convex curvature. This embodiment having a spherical radius of curvature of approximately 255 mm, with a focal point of approximately 127.5 mm emulates the standard camera lens with a 26 mm focal length and an f/1.8 aperture.

FIG. 10 illustrates the convex mirrored surface extending from the upper portion 1000 of the body, defined as proximate to, at, close to, or near, the top side 350A, to the lower portion 1005 of the body, defined as proximate to, at, close to, or near the bottom side 350C of the body, in this example embodiment. The mirrored surface forms an arc, either a spherical curve or an elliptical curve, that bulges away from the front side 325 of the body, defining a convex arc extending from the top edge to the bottom edge.

In other embodiments, the convex mirrored surface may only extend between a portion 1010 of the back side, rather than extending between the top side and the bottom side. However, in the ideal embodiment, the convex mirrored body extends from the edge of the top side to the edge of the bottom side thereby extending the full length of device 100. This allows the reflective image to have the same dimensions as the prospective photograph taken by the device. It is understood that the back side 320 defines the mirrored surface in this embodiment, presumably by an aluminum coating over a plastic polymer body; however, in certain embodiments, the mirrored surface may attach to the body, namely the back side. In such an embodiment, the back side may be flat, for example, and the mirrored surface is convex as described herein. The mirrored surface may attach to the back side by any attaching means, such as adhesive, adhesive strips, magnets, suction cups, clips, and other means within the spirit and scope of the disclosure. However, ideally, the back side will define the mirrored surface.

With reference to FIGS. 13A through 14B, cross-section views of the convex device case are shown, according to an example embodiment. FIGS. 13A and 14A illustrate a front view of the convex device case 300 having device 100 disposed within and illustrate the cross-sectional view taken therefrom. FIG. 13A is illustrates the location of cross section A-A as shown in FIG. 13B and FIG. 14A illustrates the location of cross section B-B as shown in FIG. 14B. The side walls of the body may contain openings 350 for user access to phone features such as a charging port, volume buttons, power button, or speaker ports. Cross section A-A is a horizontal cross section through convex device case 300 and device 100. Cross-section B-B is a vertical cross section through convex device case 300 having device 100 disposed within. The convex device case includes the body 325 having the back side 320, the front side 325, and the window or opening 335 on the back side for the camera of the device. In this embodiment, the convex device case has a receiving section 330 on the front side which further includes and a lip 340, 345. Lip 340 is an inward facing wall extending from and/or on the front side towards the center of the device case 300 or body 315. Lip 340 is configured to retain the device 100 within the receiving section 330. Lip 340 extends inward on the front side from at least one side wall (350A, 350B, 350C, and/or 350D) of the body. The lip is a front side surface of the body disposed over the front side of the device. The side walls of the body may contain at least one opening 350 to provide the user access to device features such as a charging ports, volume buttons, power button, speaker ports, etc. Additionally, the side walls may be included covers for said respective opening to prevent dirt and other contaminants from harming the device 100. The side walls may include the same materials as the body and may further comprise rubber, silicon, and or other shock-absorbing polymer, or coating thereof, on the side walls and/or corners where the side walls meet. The rubber will allow the convex device case to absorb any impact caused by dropping the device case, which may prevent damage to the device 100. For purposes of this disclosure, any embodiment here comprising a receiving section may include the herein mentioned and described side walls. Moreover, it is understood that, for purposes of this description, the front side 325 comprises the side walls. The convex device case 300 further includes lip 345 on the back side 320 of the convex device case. Lip 345 contacts the posterior, or back side 110 of the device 100 to support the device and retain the device within the receiving section. In this embodiment, lip 345 prevents the device from extending into the gap 360 between the back side 110 of the device 100 and the back wall 320 of the convex device case. However, in other embodiments, as described below, the convex device case may include a lip and/or an interior wall and/or perpendicular support wall which contacts the back side 110 of device 100 to keep the device within the receiving section.

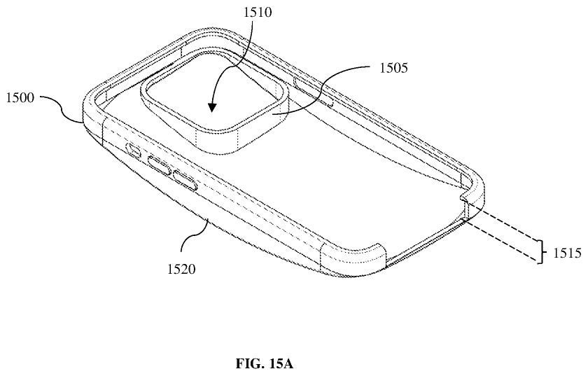

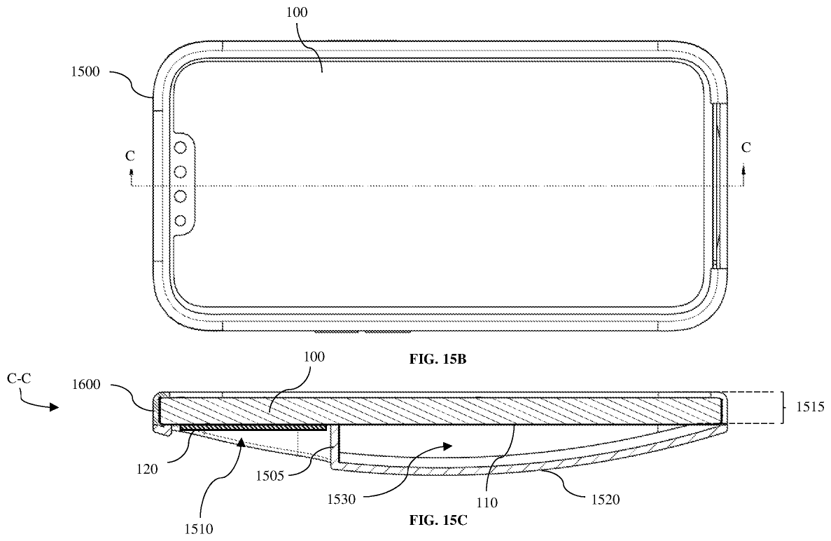

Referring now to FIG. 15A through 15C, the convex device case is shown according to a second embodiment. Namely, according to this example embodiment, the convex device case has perpendicular support wall 1505 that extends from the back side 1620 of the device case 1500 is proximate to the receiving section 1515. The perpendicular support wall is substantially vertical (may be tapered for aesthetics) as to abut the back side of the device 100 when the device is within the receiving section of the device case. The perpendicular support wall extends namely from the perimeter of the camera opening 1510 on the back side to the posterior of the device. Because a gap 1530 is formed between the back wall 1520 of the device case and the back side 110 of the device 100, the perpendicular support wall 1505 provides structural support to the spherical convex body so that the convex shape cannot be pushed inward, like a bubble. This also prevents access to the gap formed between the back wall of the device case and the device and prevents debris and dirt from collecting. It is clearly seen in the cross section across C-C in FIG. 15C that the perpendicular support wall 1505 abuts the back side of device 100 within the receiving section 1515, where the receiving section is on the front side of device 1500 configured to receive device 100. Also shown, the convex body 1500 has an opening 1510 in the back side extending to provide at least one camera on the back side 110 of the device 100 a window to capture images.

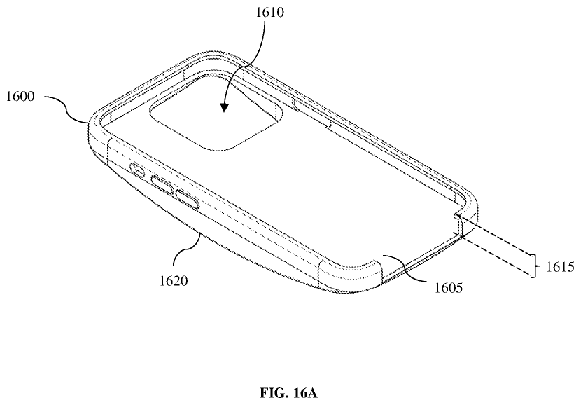

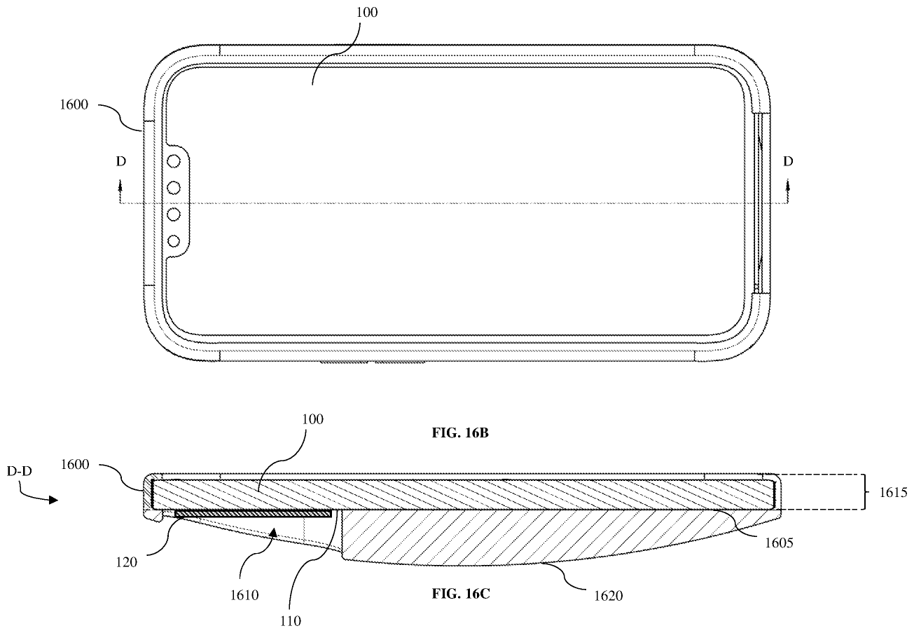

Referring now to FIG. 16A through 16C, the convex device case is shown according to a third embodiment. Namely, according to this example embodiment, the convex device case has an interior wall 1605 that is proximate to the receiving section 1615. The interior wall is a planar surface that abuts the back side of the device 100. The planar surface does not form a pocket between the convex mirrored back side and the interior wall as to provide structural support to the spherical convex shape of the back side 1620 of the body 1600. It is understood that the support between the interior wall and the back wall 1620 of the body 1600 may be uniform and/or may comprise porous structured filament (such as that formed during standard three-dimensional printing using plastics and other fibers). However, no pocket is formed between the interior wall and the back wall to provide the user with an opening to store items. It is clearly seen in the cross section across D-D in FIG. 16C that the interior wall 1605 abuts the back side of device 100 within the receiving section 1615, where the receiving section is on the front side of device 1600 configured to receive device 100. Also shown, the convex body 1600 has an opening 1610 in the back side extending through the interior wall to provide the at least one camera on the back side 110 of the device 100 a window to capture images.

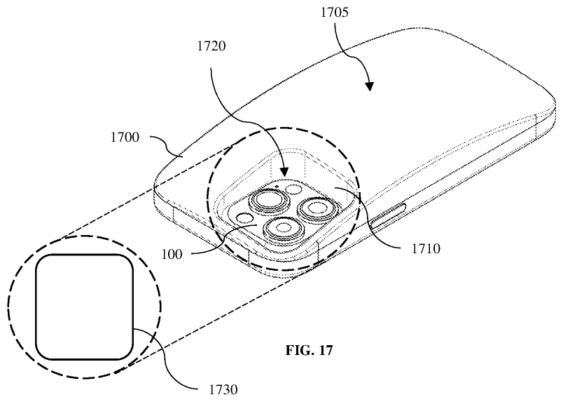

Referring now to FIG. 17, a back perspective view of the second and third example embodiments is shown. Specifically, FIG. 17 illustrates the wall 1710 extending from the back side 1705 of the convex mirrored body 1700 to the back side of device 100. The wall 1710 varies in height because the back side of the mirrored body is spherical convex. The wall extends from the back side of the body around the camera opening 1720. The wall is configured to abut the back side of the device around the camera opening to prevent dirt, dust, and debris from collecting within the gap between the back wall of the convex body and the device 100. The wall, as shown in FIG. 17, may be either the perpendicular support wall of FIGS. 15A through 15C or a portion of the supporting elements for the interior wall of FIGS. 16A though 16C. Notwithstanding the embodiment, the wall 1710 extends about the perimeter 1730 of the opening 1720. The opening provides a window for the rear cameras of the device 100.

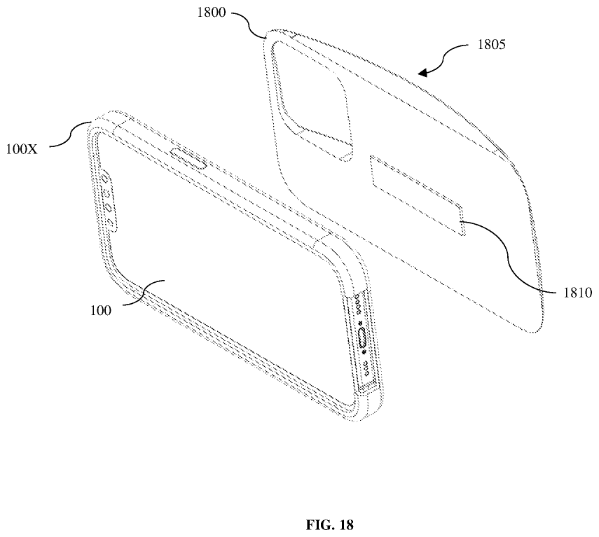

Referring now to FIG. 18, an example embodiment of the convex mirrored body is shown as an attachment or accessory to be configured to attached to a device and/or pre-existing device case. As shown, the convex mirrored body 1800 has a back side 1805 that is convex. The back side is a mirrored surface, such as plastic having a thin film of aluminum, to provide a reflection. The convex body further includes a securing element 1810 configured to removably (or affixed in certain embodiments) to a device or device case. Securing element 1810 may include any securing means such as an adhesive, magnet, hook-and-loop element, clasp, clamp, suction cup, etc., as-long-as the securing element is configured to be in attachment with the device, albeit directly to the device or indirectly attaching to another device case. As shown, the convex body 1800 is configured to attach to a pre-existing device case 100X which is secured to device 100. In certain embodiments, the convex mirrored body has the securing element defined by a receiving section such that the device 100 and/or device case 100X is configured to mate with the receiving section. For example, device 100 may include a magnet disposed relative to the back side of the device of a first polarity, and the receiving section of the convex body 1800 may include a magnet of complementary polarity such that the convex body is configured to attach to the device. In another embodiment, for example, the device case 100X may include a first hook-and-loop element (such as the hooks) and the receiving section may include a second, complementary, hook-and-loop element (such as the loops) configured to receive the first hook and loop element. In other embodiments, the securing element may be in the form of adhesive such as pressure sensitive adhesive comprising materials such as comprise lanolin, mineral oil, petrolatum, rosin, silicone, and zinc oxide. The securing element may include a peelable backing to cover the pressure sensitive adhesive which may be made of material such as wax paper or other materials used to protect adhesive materials and be easily removable. The securing element may also be in the form of a magnet such as permanent magnets such as neodymium iron boron (NdFeB), samarium cobalt (SmCo), alnico, ceramic, ferrite magnets, etc. However, other types of securing elements may also be used and are within the spirit and scope of the present invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A convex device case for providing a mirrored, minimized image to emulate an image captured by a camera of a cellular device, the convex device case comprising:
a body comprising a front side and a back side;
a receiving section on the front side;
a mirrored surface on the back side;
wherein the mirrored surface is convex.

2. The convex device case of claim 1, wherein mirrored surface has a radius of curvature of 225 mm.

4. The convex device case of claim 1, wherein mirrored surface comprises a magnification less than 1.

5. The convex device case of claim 1, wherein the back side of the body comprises a back surface defined by the mirrored surface.

6. The convex device case of claim 1, wherein the mirrored surface is a convex mirror in attachment with the back side of the body.

7. The convex device case of claim 1, wherein the back side comprises a camera opening.

8. The convex device case of claim 1, wherein the receiving section comprises a lip extending inward from at least one side wall of the body.

9. An apparatus for providing a mirrored, minimized virtual image for a user of a rear camera of a cellular device, the device comprising:
a convex mirrored body; and
a securing element.

10. The apparatus of claim 9, wherein the securing element comprises at least one of an adhesive, a magnet, a flexible lip and a hook-and-loop element.

11. The device of claim 9, wherein the securing element is defined by a receiving section of a front side of the convex mirrored body.

12. The convex device case of claim 9, wherein the convex mirrored body comprises a mirrored surface.

13. The convex device case of claim 9, wherein the convex mirrored body comprises a mirrored surface comprising a radius of curvature of 225 mm.

14. The convex device case of claim 9, wherein the convex mirrored body emulates a camera comprising a focal length of approximately 26 mm.

15. The convex device case of claim 9, wherein the convex mirrored body comprises a mirrored surface comprising aluminum.

16. A convex device case comprising:
a body comprising a front side and a back side;
a receiving section on the front side; and
a convex surface on the back side.

17. The cell convex device case of claim 16 wherein the convex surface spans from an upper portion of the body to a lower portion of the body.

18. The cell convex device case of claim 17 wherein the convex surface comprises a mirrored portion.

19. The convex device case of claim 18, wherein the mirrored portion emulates a camera comprising a focal length of approximately 23 mm.

20. The convex device case of claim 18, wherein the mirrored portion has a magnification less than 1 and produces a virtual and upright image.
